(19) United States
(12) Patent Application Publication
(10) Pub. No.: US 2026/0105644 A1
(43) Pub. Date: Apr. 16, 2026

(54) COMPRESSION SENSING AND AWARENESS

(71) Applicant: IKIN, Inc., Dripping Springs, TX (US)

(72) Inventors: Bryan Lloyd WESTCOTT, Austin, TX (US); James Charles STIEFELMAIER, Austin, TX (US); Kristy TIPTON, Austin, TX (US); Dusty COLEMAN, Dripping Springs, TX (US)

(21) Appl. No.: 19/352,286

(22) Filed: Oct. 7, 2025

Related U.S. Application Data
(60) Provisional application No. 63/706,476, filed on Oct. 11, 2024.

(51) Int. Cl. G06T 9/00; G06N 3/04; G06N 3/0895

(52) U.S. Cl. CPC G06T 9/002; G06N 3/04; G06N 3/0895

(57) ABSTRACT

A computer implemented method includes training a machine learning model on full resolution video. New full resolution video is received. Diffusion-based encoding is used to transform the new full resolution video into compressed video. The machine learning model is utilized to perform automated decision-making on the compressed video.

### CROSS-REFERENCE TO RELATED APPLICATION

This application claims priority to U.S. Provisional Patent Application 63/706,476, filed Oct. 11, 2024, the contents of which are incorporated herein by reference.

### FIELD

The present disclosure documents methods for performing monitoring and detection within diffusion-based video compression, with maximal reuse of pre-trained image-domain discriminative models (e.g., classifiers trained on non-compressed video), including uncertainty information and outlier detection models.

### BACKGROUND

Current Sensing and Awareness systems analyze live or prerecorded video feeds using Computer Vision algorithms to find objects of interest. This requires sending raw video footage or the uncompressing of video data to execute the process. With the latest evolutions of Generative AI combined with AI's understanding of “Latent Space”, we are no longer limited to traditional Computer Vison algorithms that sense changes the same way as the human eye, but rather we can have AI review heavily compressed data within the latent space and only decode the data stream as needed.

### SUMMARY

A computer implemented method includes training a machine learning model on full resolution video. New full resolution video is received. Diffusion-based encoding is used to transform the new full resolution video into compressed video. The machine learning model is utilized to perform automated decision-making on the compressed video.

### BRIEF DESCRIPTION OF THE DRAWINGS

The invention is more fully appreciated in connection with the following detailed description taken in conjunction with the accompanying drawings, in which:

FIG. 1 shows a pre-trained image-domain discriminator and associated lossless image to train a compressed latent-domain discriminator.

FIG. 2 shows an ensemble of video frames used to first produce per-pixel distribution information and then use those distributions to compute per-pixel confidence information.

FIG. 3 illustrates the computation of per-pixel uncertainty (variances) as the source image is perturbed.

FIG. 4 illustrates a system for hybrid transmission of compressed video and original video.

FIG. 5 illustrates a compressive sensing approach at the collector/transmitter in which lower-quality sensors may be used to directly generate a diffusion-based codec.

Like reference numerals refer to corresponding parts throughout the several views of the drawings.

### DETAILED DESCRIPTION

### Introduction

### Conditional Diffusion for Video Compression, Streaming, and Realtime Sensing/Monitoring

In one aspect the disclosure relates to a conditional diffusion process capable of being applied in video communication and streaming of pre-existing media content. As an initial matter, consider that the process of conditional diffusion may be characterized by Bayes' theorem:

$$p ( x \vert y ) = p ( y \vert x ) * p ( x ) / p ( y )$$

One of the many challenges of practical use of Bayes' theorem is that it is intractable to compute p(y). One key to utilizing diffusion is to use score matching (log of the likelihood) to make p(y) go away in the loss function (the criteria used by the machine-learning (ML) model training algorithm to determine what a “good” model is. This yields:

$$E\_p ( x ) log [ p ( x \vert y ) ] = E\_p ( x ) log [ p ( y \vert x ) p ( x ) / p ( y ) ] = E\_p ( x ) [ log ( p ( y \vert x ) ) + log ( p ( x ) - log ( p ( y ) ) ] = E\_p ( x ) [ log ( p ( y \vert x ) ) + log ( p ( x ) ]$$

Since p(x) remains unknown, an unconditional diffusion model is used, along with a conditional diffusion model for p(y|x). One principal benefit of this approach is that it is learned how to invert a process (p(y|x)) but balance that progress with the prior (p(x)), which enables learning from experience and provides improved realism (or improved adherence to a desired style). The use of the high-quality diffusion models will allow low-bandwidth, sparse representations (y) to be improved.

How would this approach work in a 3D aware analysis context? In the case of novel views, one key insight is that the subject matters pose relative to the captured images can vary. This means that a receiver with access to q(y|x) can query a new pose by moving those rigid 3D coordinates (y) around in 3D space to simulate parallax. This has two primary benefits:
1. they are sparse and thus require less bandwidth
2. They can be rotated purely at the receiver thus providing parallax for novel reconstruction

A novel view system would begin by training a diffusion model (either from scratch or as a customization as is done with LoRA) on a corpus of selected images (x), and subject matter coordinates (y) derived from the images, for the end user desiring to transmit their likeness. Those images may be in a particular style: e.g., in business attire, with combed hair, make-up, etc. After that model q(y|x) is transmitted, you can then then transmit per-frame face mesh coordinates, and then we simply use head-tracking to query the view we need to provide parallax. The key is an unconditional noise process model q(y|x) is sent from a transmitter to a receiver once. After the unconditional noise process has been sent, the transmitter just sends per-frame coordinates (y).

Set forth below are various possible extensions made possible by this approach:
Additional dimensions of information could be provided with each identified object, for example RGB values, which gives some additional information on the extrinsic illumination.
Comparisons from frame to frame can be made and if the diff threshold is within a specified delta, no data needs to be transferred and the data from the previously transmitted frame can be utilized.
Any other additional low bandwidth/sparse information (discussed in compression section) could be added, including background information. The relative poses of the subject matter and the background could be assisted with embedded or invisible (to the human eye) fiducial markers such as Augmented Reality University of Cordoba (ArUco) markers, which are binary fiducial markers used in augmented reality and computer vision.
If we track the identified object, we could selectively render/upsample the output based on the location being at any given moment, which saves rendering computation.

For more general and non-3D-aware applications (e.g., for monocular video) the transmitter could use several sparse representations for transmitted data (y) including:
canny edge locations, optionally augmented with RGB and/or depth (from a library such as DPT)
features used for computer vision (e.g., DINO, SIFT)
a low-bandwidth (low-pass-filtered) and down sampled version of the input.
AI feature correspondences: transmit the feature correspondence locations and ensure the conditional diffusion reconstructs those points to correspond correctly in adjacent video frames.
Note: this is different from the TokenFlow video diffusion approach as it enforces the correspondences on the generative stylized output

This process may be utilized in a codec configured to, for example, compress and transmit new or existing video content. In this case, the transmitter would train q(x) on a whole video, a whole series of episodes, a particular director, or an entire catalog. Note that such training need not be on the entirety of the diffusion model but could involve training only select layers using, for example, a low-rank adapter such as LoRA. This model (or just the low-rank adapter) would be transmitted to the receiver. Subsequently, the low-rank/low-bandwidth information would be transmitted, and the conditional diffusion process would reconstruct the original image. In this case, the diffusion model would learn the decoder, but the prior (q(x)) keeps it grounded and should reduce the uncanny valley effect.

### Implementation Details

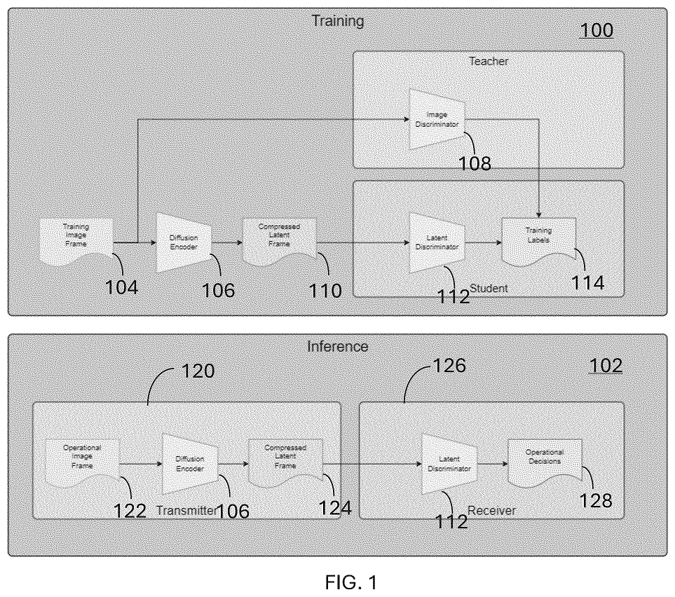

FIG. 1 shows one way we may use a pre-trained image-domain discriminator and associated lossless image to train a compressed latent-domain discriminator which may then be used operationally at the receiver using only the compressed video. FIG. 1 illustrates a training phase 100 and an inference phase 102. During training, training image frames 104 are supplied to a diffusion encoder 106 and an image discriminator 108. The diffusion encoder 106 forms compressed latent frames 110, which are applied to a latent discriminator 112. Image discriminator 108 supplies training labels 114.

In the inference phase 102, a transmitter 120 supplies operational image frames 122, which are applied to the diffusion encoder 106 to form compressed latent frames 124. At the receiver 126, the latent discriminator 112 receives the data and operational decisions are made by an operational decision module 128.

The diffusion encoder 106, image discriminator 108 and latent discriminator 112 are each a machine (e.g., a computer) with a network interface circuit for communication with other networked machines, a processor and a memory storing instructions executed by the processor to implement the stated operations.

### Confidence Distillation

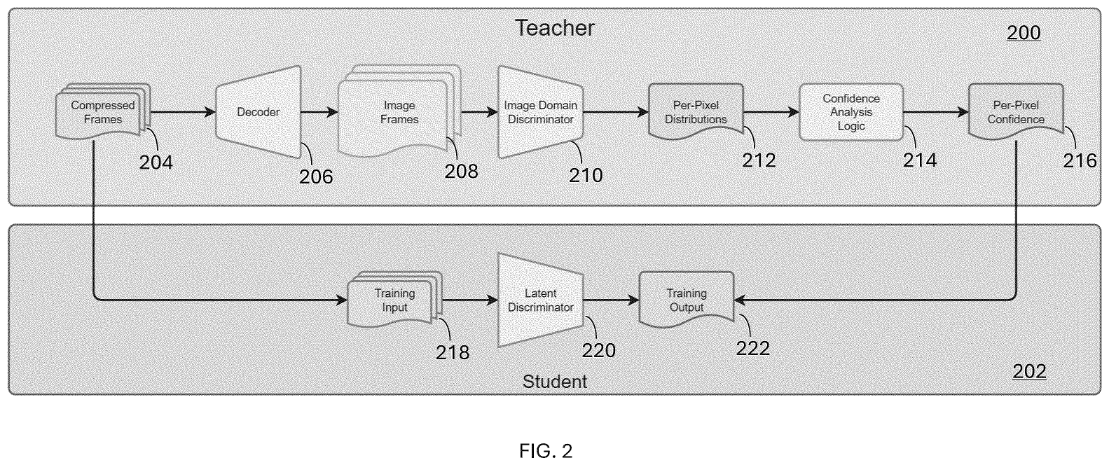

FIG. 2 shows one way in which we may use an ensemble of video frames to first produce per-pixel distribution information (either directly via methods such as Bayesian networks or sample distributions) and then use those distributions to compute per-pixel confidence information specific to the problem domain. That per-pixel confidence may be transmitted directly from the receiver, or it may be used train a secondary network to produce confidence information directly from an ensemble of latent video frames.

FIG. 2 illustrates a teacher process 200 and a student process 202. Compressed frames 204 are applied to a decoder 206, which forms image frames 208, which are applied to an image domain discriminator 210. The image domain discriminator 210 forms per-pixel distributions 212, which are applied to confidence analysis logic 214. This results in per-pixel confidence values 216.

In the student process 202, the compressed frames 204 are received as training input 218 for the latent discriminator 220. Training output 222 includes output from the latent discriminator 220 and the per-pixel confidence data 216.

### Decoding Uncertainty

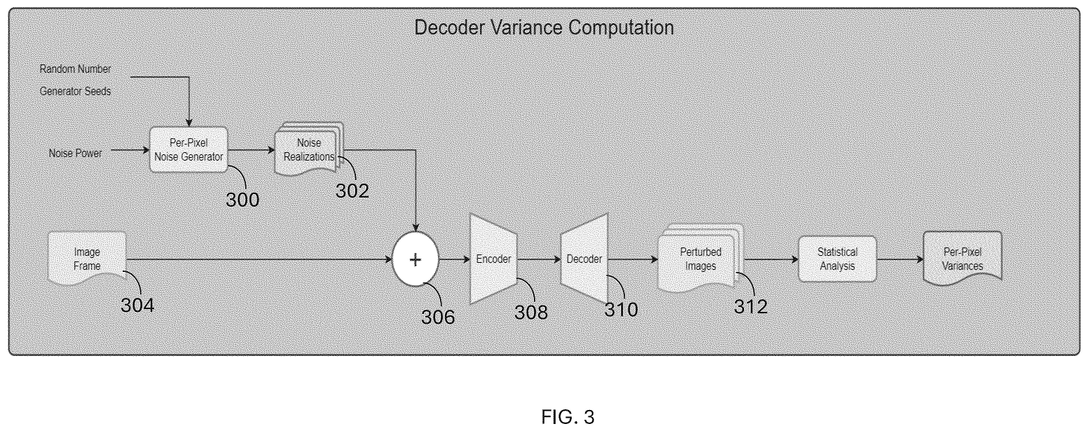

FIG. 3 illustrates the computation of per-pixel uncertainty (variances) as the source image is perturbed. A per-pixel noise generator 300 produces noise realizations 302 that are combined with an image frame 304 at adder 306. The output from the adder 306 is applied to an encoder 308 and a decoder 310 to form perturbed images 312.

The appropriate noise may be determined through sensor information (i.e., exposure/aperture/ISO etc., or via some other analysis of an ensemble of frames). This computation may be performed at the transmitter and sent periodically to the receiver. This ancillary information may be communicated (e.g., overlaid on the decoded image) to ensure the recipient does not over-estimate the precision of the diffusion-based codec based on experience from conventional codecs. Note that we may also add noise inside the encoder-decoder pair to communicate uncertainty due to corrupt transmission.

### Hybrid Transmission Methods

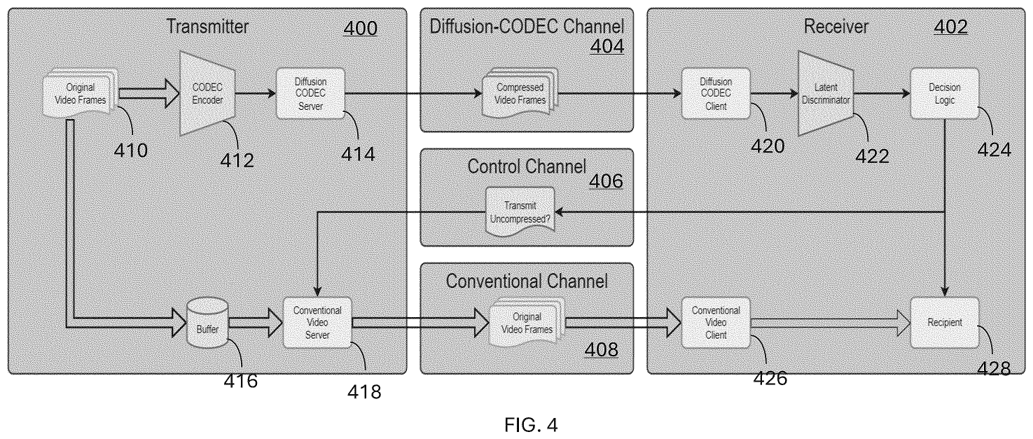

FIG. 4 illustrates a system for hybrid transmission. Hybrid transmission means full resolution video is transmitted when detection thresholds are exceeded at the receiver. FIG. 4 shows a transmitter 400 and a receiver 402 in communication via a diffusion-CODEC channel 404, a control channel 406, and a convention video channel 408. The transmitter 400 processes original video frames 410 with a CODEC encoder 412 to produce output sent to a diffusion CODEC server 414, which applies the compressed video frames to the channel 404. The original video frames are also sent to buffer 416. Original video frames are sent by a conventional video server 418 in response to a control signal from control channel 406.

The receiver 402 has a diffusion CODEC client 420 and a latent discriminator 422. Output from the latent discriminator 422 is applied to a decision logic module 424, which determines when original video frame data is required. The decision logic module 424 generates the control signal applied to control channel 406 to obtain the full video from the conventional video server 418. The receiver has a conventional video client 426 and a recipient device display 428.

### Compressive Sensing

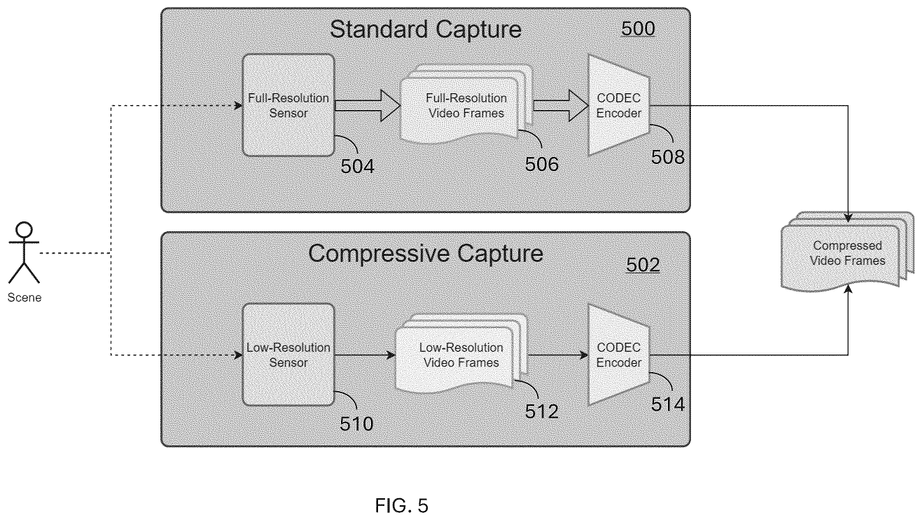

FIG. 5 illustrates a compressive sensing approach at the collector/transmitter in which lower-quality sensors may be used to directly generate our diffusion-based codec. As our method requires only very-low-quality guidance, lower cost (size, weight, power, complexity) sensors may be used. Note that this may also be used in hybrid mode and note that a LoRA-customized decoder may be trained in advance with a separate high-quality sensor.

The standard capture process 500 uses full-resolution sensors 504 to produce full-resolution video frames 506, which are processed by a CODEC encoder 508. The compressive capture process 502 uses low-resolution sensors 510 to produce low-resolution video frames 512, which are processed by a CODEC encoder 514.

### Applications of the Disclosed Technology

Since many domain-specific ML models (e.g., classifiers and object detectors) have been trained in the image-domain (e.g., conventional human-interpretable RGB images), we reuse the knowledge learned in these models for similar functionality in the compressed domain. We can use methods such as transfer learning and model distillation to perform that task. That is, a machine learning model trained on full resolution video data is used to make decisions in the compressed domain.

Any modeling of uncertainty (e.g., confidence on a classification), particularly those mapped back to the image domain may be similarly reused in our compressed latent domain. A variety of methods may be used to generate confidence information including Bayesian neural networks or other methods to output predictive distributions (for which statistics such as mean, median, variance, interquartile range, etc. may be computed), collection of sample statistics over multiple adjacent frames, collection of image perturbations and associated prediction changes.

We also recognize that effective applications of diffusion-based compressive video do not require 100% use of compressive video. Instead, we may operate in hybrid mode by performing sensing and detection on the compressive domain using lower bandwidth and only trigger a full-resolution stream which consumes more resources when detection thresholds are exceeded.

For this hybrid mode, we may set more conservative thresholds in the latent space than is used by the conventional non-compressed video stream discriminators. For example, we may reduce the probability of false negatives (type II errors), even if it increases the probability of false positives (type I errors).

In cases where network throughput is the bottleneck, sensors may buffer full resolution video and only transmit that higher-bandwidth data when latent-space detection thresholds are met. This ensures that human-interpretable output is always available to verify decisions even if the compression is not lossless and latency of decompression is high

We may also combine any or all of these ideas with compressive sensing, where a lower-resolution sensor directly encodes to the lower-dimensional latent space, which may often reduce size, weight, power and cost of the sensor.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include but are not limited to: magnetic media, optical media, magneto-optical media, and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using an object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer implemented method, comprising:
training a machine learning model on full resolution video;
receiving new full resolution video;
using diffusion-based encoding to transform the new full resolution video into compressed video; and
utilizing the machine learning model to perform automated decision-making on the compressed video.

2. The computer implemented method of claim 1 further comprising:
applying the full resolution video to an image discriminator to form training labels; and
applying the training labels to the compressed video.

3. The computer implemented method of claim 1 further comprising:
processing the full resolution video to form confidence classifications; and
applying the confidence classifications to the compressed video.

4. The computer implemented method of claim 1 further comprising:
combining the full resolution video with noise to form perturbed images; and
making predictions about the compressed video based upon the perturbed images.

5. The computer implemented method of claim 1 further comprising:
buffering at a transmitter buffered full resolution video;
sending from the transmitter compressed video corresponding to the buffered full resolution video; and
processing at a receiver the compressed video and periodically requesting from the transmitter buffered full resolution video.

6. The computer implemented method of claim 1 further comprising:
processing the full resolution video to form labeled sensor data;
using diffusion-based encoding to transform low-resolution sensor data into compressed low-resolution sensor data; and
applying the labeled sensor data to the compressed low-resolution sensor data.
